(19) United States
(12) Patent Application Publication
(10) Pub. No.: US 2022/0149906 A1
(43) Pub. Date: May 12, 2022

(54) METHOD OF TWO-LAYER UPLINK TRANSMISSION WITH CYCLIC DELAY DIVERSITY

(71) Applicant: NTT DOCOMO, INC., Tokyo (JP)

(72) Inventors: Nadisanka Rupasinghe, Tokyo (JP); Haralabos Papadopoulos, Tokyo (JP)

(73) Assignee: NTT DOCOMO, INC., Tokyo (JP)

(21) Appl. No.: 17/599,978

(22) PCT Filed: Mar. 27, 2020
(86) PCT No.: PCT/US2020/025190

§ 371 Date: Sep. 29, 2021

Related U.S. Application Data
(60) Provisional application No. 62/826,403, filed on Mar. 29, 2019.

(51) Int. Cl. H04B 7/0456; H04B 7/0404; H04B 7/06

(52) U.S. Cl. CPC H04B 7/0473; H04B 7/0404; H04B 7/0691; H04B 7/0671; H04B 7/0689; H04B 7/0639

(57) ABSTRACT

A method of applying rank two transmission from a plurality of sets of coherent antennas of a user equipment (UE) in a wireless communication system includes: transmitting two information streams using a first set from the plurality of sets of coherent antennas of the UE; and transmitting the two information streams using a second set from the plurality of sets of the coherent antennas of the UE. The first set and the second set are incoherent with respect to each other. The two information streams are common to the first set and the second set.

### TECHNICAL FIELD

One or more embodiments disclosed herein relate to a method of implementing two-layer transmission with Cyclic Delay Diversity (CDD).

### BACKGROUND

5G New Radio (NR) supports uplink (UL) multi-antenna transmission Physical Uplink Shared Channel (PUSCH) for up to 4 layers.

In a NR system, a user equipment (UE) may be configured in at least two different modes for multi-antenna PUSCH transmission. In some cases, a UE may be configured with a Codebook based multi-antenna PUSCH transmission and in some other cases a UE may be configured with a non-Codebook based multi-antenna PUSCH transmission.

Codebook-based multi-antenna PUSCH transmission being typically implemented in a case where UL/downlink (DL) reciprocity does not hold. In this case, the network (NW) informs the UE of at least the Transmitted Precoding Matrix Indicator (TPMI), the Scheduling Request Indicator (SRI), and the rank of the channel. Furthermore, the UE capability needs to be known on the NW side in this scenario. Such a configuration requires Sounding Reference Signals (SRSs) for multi-port channel sounding.

Non-codebook-based multi-antenna PUSCH transmission, on the other hand, assumes channel reciprocity. Accordingly, no TPMI feedback is required from the NW in this scenario.

Returning to Codebook-based multi-antenna PUSCH transmission, coherence between different antennas may be important for the Codebook-based PUSCH implementation. As an example, it may be important for the NW to know the UE capability to the extent that the relative phase between the signals transmitted on two antennas can be well controlled. In other words, it may be advantageous for the NW to know whether the UE is capable of Full coherence, Partial coherence, or Non-coherence.

Based on the capability of the UE, the gNodeB (gNB) may assign only relevant codewords from the codebook using TPMI. As an example, FIG. 1 shows UL codebooks for the case of two antenna ports. As another example, FIG. 2 shows an example of a single-layer UL codebook for four antenna ports.

Further, in NR Rel. 15, there may be two main restrictions preventing UEs with non-coherent or partially coherent antennas from full power UL transmission. The first main restriction being of TPMIs for UEs with non-coherent or partially coherent antennas. FIG. 3 shows an example of a precoding matrix W for single-layer transmission using four antenna ports with transform precoding enable. As can be seen in FIG. 3, codewords are pre-assigned based on UE capability. For example, for a UE with 2 non-coherent antennas, the precoders are restricted to [1,0]^{T} and [0,1]^{T}. If UE is powered by 2 PAs, each with a 20 dBm output rating, UE cannot tx with full power (23 dBm) due to precoder restriction.

The second main restriction being in UL power allocation as defined in Rel. 15. TS 38.312, § 7.1 defines UL Tx power being scaled according to the ratio number of PUSCH Tx ports to the total configured ports. TS 38.312, § 7.1 describes for a PUSCH transmission on active UL BWP b, as described in Subclause 12, of carrier f of serving cell c, a UE first scales a linear value \hat{P}_{PUSCH,b,f,c} (i, j, q_{d}, l) of the transmit power P_{PUSCH,b,f,c}(i, j, q_{d}, l), with parameters as defined in Subclause 7.1.1, by the ratio of the number of antenna ports with a non-zero PUSCH transmission power to the number of configured antenna ports for the PUSCH transmission scheme. The UE splits the resulting scaled power equally across the antenna ports on which the UE transmits the PUSCH with non-zero power.

As a result, the UEs assigned with TPMIs having zero entries cannot transmit with full Tx power. For example, the UE has 2 non-coherent antenna ports being assigned and the precoder is [1,0]^{T}. Here, the first antenna port is assigned \hat{P}_{PUSCH}/2 transmit power (linear value) to transmit PUSCH. Thus, for a class-3 UE that is powered by 2 PAs, each with a 23 dBm output rating, the maximum transmit power with precoder [1,0]^{T} is 3 dB below the maximum possible power the UE can transmit.

### CITATION LIST

### Non-Patent Reference

[Non-Patent Reference 1] Erik Dahlman, Stefan Parkvall, Johan Skold. “5G NR: The Next Generation Wireless Access Technology.”
[Non-Patent Reference 2] 3GPP, TS 38.211, “5G; NR; Physical channels and modulation”
[Non-Patent Reference 3] 3GPP TSG RAN WG1 Meeting #94b, “RAN1 Chairman's notes,” Chengdu, China, 8-12 Oct. 2018
[Non-Patent Reference 4] 3GPP TSG RAN WG1 Meeting #95, “RAN1 Chairman's notes,” Spokane, USA, 21-25 Nov. 2018.
[Non-Patent Reference 5] 3GPP TSG RAN WG1 Meeting AH 1901, “RAN1 Chairman's notes,” Taipei, Taiwan, 21-25 Jan. 2019.
[Non-Patent Reference 6] 3GPP TSG RAN WG1 Meeting #96, “RAN1 Chairman's notes,” Athens, Greece, Feb. 25-Mar. 1, 2019

### SUMMARY

One or more embodiments provide a method of applying rank two transmission from a plurality of sets of coherent antennas of a user equipment (UE) in a wireless communication system. The method includes: transmitting two information streams using a first set from the plurality of sets of coherent antennas of the UE; and transmitting the two information streams using a second set from the plurality of sets of the coherent antennas of the UE. The first set and the second set are incoherent with respect to each other. The two information streams are common to the first set and the second set.

One or more embodiments provide a method of applying cyclic delay diversity (CDD) across coherent pairs of antennas of a user equipment (UE) in a wireless communication system. The method includes: transmitting two information streams across a first set of coherent antennas of the UE; and transmitting the two information streams across the second set of the coherent antennas of the UE. The two information streams across the first set are transmitted with a delay based on the CDD from the two information streams transmitted across the second set.

One or more embodiments provide a method of applying single-bit port-stream mapping. The method includes determining, with the UE, port channel gains for a two-layer, four port uplink (UL) transmission of a partial coherent user equipment.

One or more embodiments provide a method of precoding in a wireless communication system. The method includes obtaining, with a base station (BS), a release 15 codebook including at least one of partial coherent codewords or full coherent codewords; and applying, with the BS, precoding to a stream based on the release 15 codebook.

One or more embodiments provide a method of precoding in a wireless communication system. The method includes defining, in the wireless communication system, a codebook including one or more codewords applicable to two-layer, four port uplink transmission for a user equipment (UE). The one or more codewords apply to zero forcing (ZF) precoding of coherent antenna pairs for the UE.

Other embodiments and advantages of the present invention will be recognized from the description and figures.

### BRIEF DESCRIPTION OF THE DRAWINGS

FIG. 1 is a diagram showing a UL codebook for a case of two or more antenna ports.

FIG. 2 is a diagram showing a single-layer UL codebook for four antenna ports.

FIG. 3 is a diagram showing a precoding matrix W for single-layer transmission using four antenna ports with transform precoding enabled.

FIG. 4 is a diagram showing a configuration of a wireless communication system according to one or more embodiments of the present invention.

FIG. 5 shows an example in accordance with one or more embodiments.

FIG. 6 shows a table indicating the port-stream mapping according to one or more embodiments.

FIG. 7 shows a table indicating precoding matrix for two-layer transmission according to one or more embodiments.

FIG. 8 shows an example where symbols are assigned to ports according to one or more embodiments.

FIG. 9 shows a block diagram of an assembly in accordance with one or more embodiments.

FIG. 10 shows a block diagram of an assembly in accordance with one or more embodiments.

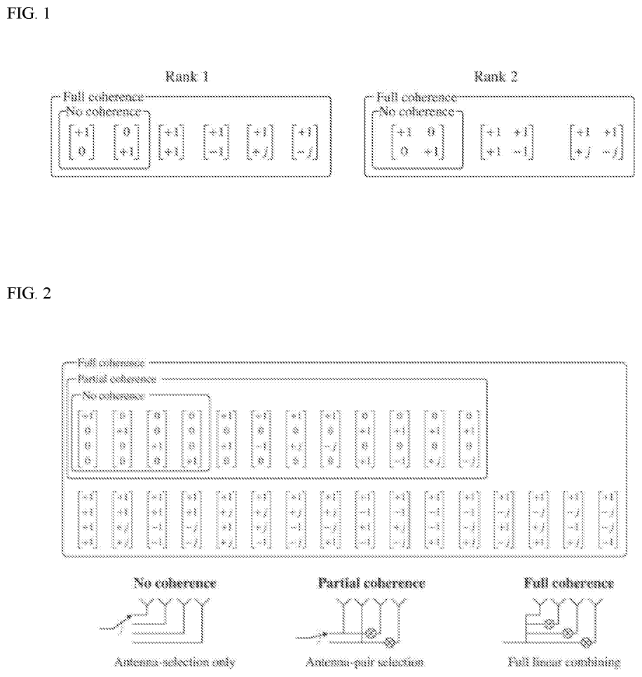

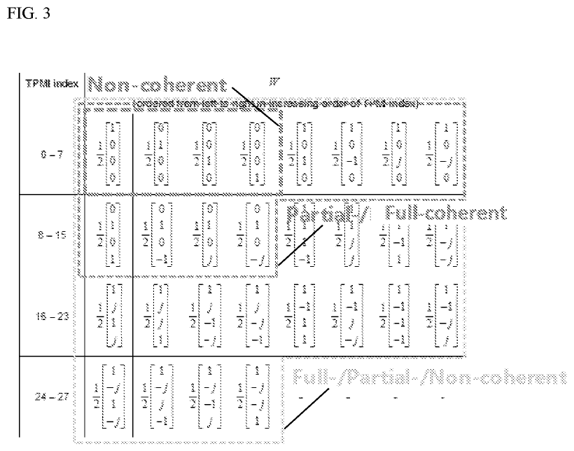

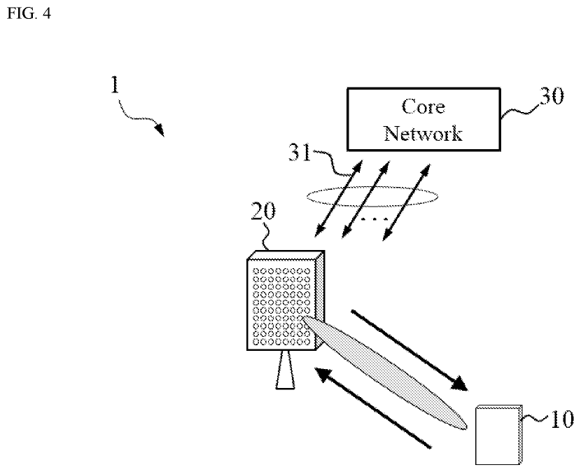

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

A wireless communication system 1 according to one or more embodiments of the present invention will be described below with reference to FIG. 4.

As shown in FIG. 4, the wireless communication system 1 includes a User Equipment (UE) 10, a Base Station (BS) 20, and a core network 30. The wireless communication system 1 may be an NR system or a Long Term Evolution (LTE)/LTE-Advanced (LTE-A) system.

The BS 20 communicates with the UE 10 via multiple antenna ports using a multiple-input and multiple-output (MIMO) technology. The BS 20 may be gNodeB (gNB) or Evolved NodeB (eNB). The BS 20 receives downlink packets from a network equipment such as upper nodes or servers connected on the core network 30 via the access gateway apparatus, and transmits the downlink packets to the UE 10 via the multiple antenna ports. The BS 20 receives uplink packets from the UE 10 and transmits the uplink packets to the network equipment via the multiple antenna ports.

The BS 20 includes antennas for MIMO to transmit radio signals between the UE 10, a communication interface to communicate with an adjacent BS 20 (for example, X2 interface), a communication interface to communicate with the core network (for example, S1 interface), and a CPU (Central Processing Unit) such as a processor or a circuit to process transmitted and received signals with the UE 10. Functions and processing of the BS 20 described below may be implemented by the processor processing or executing data and programs stored in a memory. However, the BS 20 is not limited to the hardware configuration set forth above and may include any appropriate hardware configurations. Generally, a plurality of the BSs 20 may be disposed so as to cover a broader service area of the wireless communication system 1.

The UE 10 communicates with the BS 20 using the MIMO technology. The UE 10 transmits and receives radio signals such as data signals and control signals between the BS 20 and the UE 10. The UE 10 may be a mobile station, a smartphone, a cellular phone, a tablet, a mobile router, or information processing apparatus having a radio communication function such as a wearable device.

The UE 10 includes a CPU such as a processor, a RAM (Random Access Memory), a flash memory, and a radio communication device to transmit/receive radio signals to/from the BS 20 and the UE 10. For example, functions and processing of the UE 10 described below may be implemented by the CPU processing or executing data and programs stored in a memory. The UE 10 is not limited to the hardware configuration set forth above and may be configured with, e.g., a circuit to achieve the processing described below.

In one or more embodiments, the following examples for UL full power transmission may be applied. In one or more embodiments, refinement and/or adjustment of UL codebook being supported may be applied. For example, as Example 1, a new codebookSubset for non-coherent and partial-coherent transmission capable UEs 10 may be supported. Additionally, the introduction of additional scaling factor(s) for an uplink codebook may be applied.

Alternatively or additionally, as Example 2, the UE 10 transparently applies a small cyclic or linear delay.

Alternatively or additionally, a power control mechanism may be modified to support UL full power transmission without precluding the use of full rated PA(s). Full rated PA refers to a PA having power not lower than that of the power class.

Alternatively or additionally, it may be up to UE implementation, rendering little or no impact on specifications.

In one or more embodiments, full TX power UL transmission with multiple power amplifier is supported at least for codebook based UL transmission for non-coherent and partial/non-coherent capable UEs. This may be a UE optional feature.

In one or more embodiments, for full TX power UL transmission, one additional option may be added for the precoders with 0 entries, the linear value \hat{P}_{PUSCH,b,f,c}(i, j, q_{d}, l) of a PUSCH transmission power is scaled by a ratio α_{Rel-16}. The value of α_{Rel-16} is selected up to UE implementation within the range of [α_{Rel-15}, 1], where α_{Rel-15} is the ratio of the number of antenna ports with a non-zero PUSCH transmission power to the number of configured antenna ports for the PUSCH transmission scheme as defined in NR Rel-15 specification. Consistently, the UE may be required to maintain consistent α_{Rel-16} value on different occasions of PUSCH transmissions with the same precoder for PUSCH

In one or more embodiments, for full TX power UL transmission, it may be up to the UE implementation with UE capability signaling of full power transmission in UL.

In other words, one or more embodiments may employ a new codebook subset for non-coherent or partial coherent transmission capable UEs along with potentially applying cyclic delay.

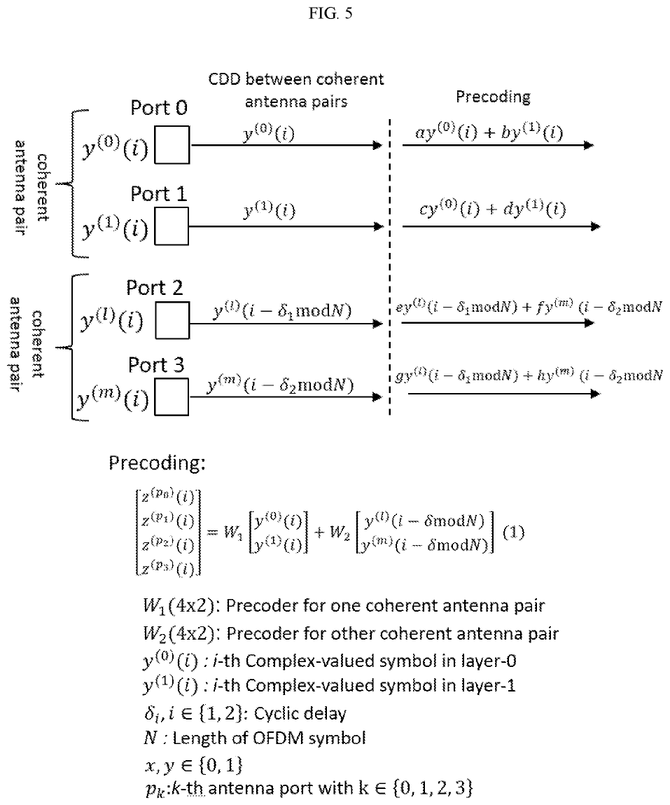

FIG. 5 describes two-layer transmission with cyclic delay diversity according to one or more embodiments. For example, a partial coherent capable UE has 4 pairwise coherent antennas. In this scenario, the above Example 1 and Example 2 may be used to enhance the achievable sum-rate with two-layer transmission.

As described in FIG. 5, spatial multiplexing may be achieved within coherent antenna pair. y⁽⁰⁾(i) and y⁽¹⁾(i) represent i-th complex-valued symbols in layer-0 and layer 1, respectively. y⁽⁰⁾(i) and y⁽¹⁾(i) are assigned to one coherent antenna pair of the UE 10 (e.g., a pair of port 0 and port 1). To enhance the received SNR further, cyclically shifted versions of the same symbols, y^{(l)}(i−δ₁ mod N) and y^{(m)}(i−δ₂ mod N) are assigned to the other coherent antenna pair (e.g., a pair of port 2 and port 3).

According to one or more embodiments, the UE 10 includes a plurality of sets of coherent antennas (e.g., ports 1, 2, 3, and 4). For example, the first set is a set of port 0 and port 1 and the second set is a set of port 2 and port 3. The UE 10 transmits, using the first set of the coherent antennas, two information streams (i.e. y⁽⁰⁾(i), y⁽¹⁾(i) in FIG. 5 correspond to i-th symbol of stream 1 and stream 2, respectively). The UE 10 transmits, using the second set of the coherent antennas, the same two information streams as the information streams transmitted using the first set. The first set and the second set are incoherent with respect to each other. The two information streams are common to the first set and the second set.

As another example, the two information streams across a first set of a plurality of sets of coherent antennas of the UE 10 may be transmitted with a delay based on the CDD from the two information streams transmitted across a second set of a plurality of sets of the coherent antennas of the UE 10.

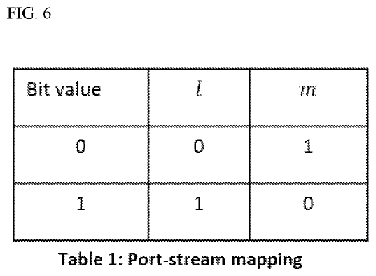

Additionally, in order to maximize received power of both streams, single bit port-stream mapping is introduced as in Table 1 of FIG. 6.

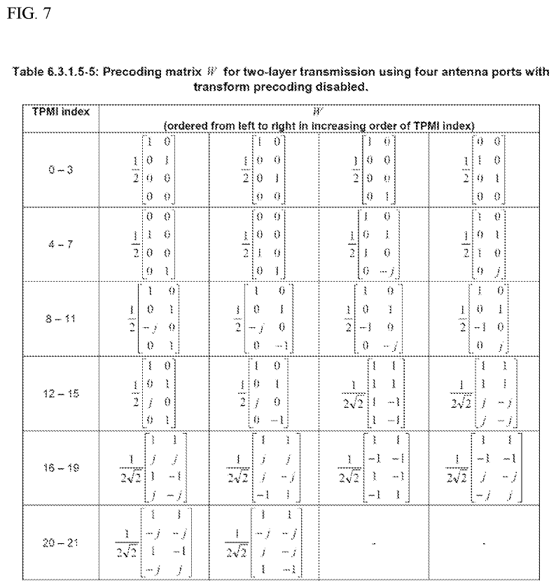

In another example, how to determine a precoder to achieve spatial multiplexing may be considered. In particular, W₁ and W₂ can be identified among several options. As one option, reusing Rel. 15 four port two-layer transmission codebook is considered. For example, an estimated UE channel based on SRS, the BS 20 can configure a TPMI corresponding to a particular precoder W from Table 6.3.1.5-5 [2] of FIG. 7 using DCI. TPMI indices of available precoders for such configuration are {6, 7, 8 . . . 21} from Table 6.3.1.5-5 [2].

In this scenario,

$$W = [ \begin{matrix}a & b \\ e & f \\ g & h \\ c & d\end{matrix} ] .$$

Further, the UE 10 can then determine W₁ and W₂ from W as,

$$\overbrace{[ \begin{matrix}a & b \\ c & d \\ 0 & 0 \\ 0 & 0\end{matrix} ]}^{{W}_{1}} = \overbrace{[ \begin{matrix}1 & 0 & 0 & 0 \\ 0 & 0 & 0 & 1 \\ 0 & 0 & 0 & 0 \\ 0 & 0 & 0 & 0\end{matrix} ]}^{{W}_{1}^{′}} W \overbrace{[ \begin{matrix}0 & 0 \\ 0 & 0 \\ e & f \\ g & h\end{matrix} ]}^{{W}_{2}} = \overbrace{[ \begin{matrix}0 & 0 & 0 & 0 \\ 0 & 0 & 0 & 0 \\ 0 & 1 & 0 & 0 \\ 0 & 0 & 1 & 0\end{matrix} ]}^{{W}_{2}^{′}} W .$$

As another example, the UE 10 can also determine W₁ by picking p-th and q-th rows from W and W₂ by picking p′-th and q′-th rows from W. Here, p, q, p′, q′∈{1, 2, 3, 4} and p≠q≠p′≠q′.

As another example, W₁′ and W₂′ may not be limited to above matrices. It is possible to support other variations as well. For example, there can be a single matrix performing the same thing, i.e., extracting W₁ and W₂ from W

Additionally, as another example, a UE channel for each coherent antenna pair may be estimated based on SRS, where the BS 20 can determine a zero forcing (ZF) precoder for each coherent antenna pair. Alternatively or additionally, the BS 20 can explicitly feedback the identified precoder(s) W or W₁ and W₂ in DCI. Alternatively or additionally, new codewords can be added to the existing codebook and pick the closest codeword to the ZF precoder for two coherent antenna pairs from the codebook and signal it to UE using TMPI in DCI.

In one or more embodiments, single bit port-stream mapping in order to maximize received power of both streams may be considered. In this scenario, the BS 20 first assigns two streams to a coherent antenna pair. Based on the estimated channel gains (using SRS) for that coherent antenna pair, streams are assigned to other coherent antenna pair as follows.

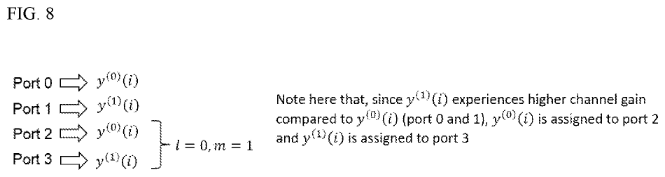

For example, estimated channel gain at the BS 20 from 4 ports may be gₚ_{₀}, gₚ_{₁}, gₚ_{₂}, gₚ_{₃} for port 0, 1, 2 and 3 respectively. Port 0 and 1 are a coherent pair whereas port 2 and 3 are another coherent pair. Further, gₚ_{₀}<gₚ_{₁} and gₚ_{₂}>gₚ_{₃} may be assumed. Then, symbols are assigned to ports as shown in FIG. 8. The channel gain may be referred to as a port channel gain.

In one or more embodiments, the UE 10 may determine port channel gains for a two-layer, four port UL transmission of a partial coherent UE.

In this example, there will be an additional 1 bit in the DCI to inform port-stream mapping to UE. In one or more embodiments, the identification of cyclic delay δᵢ, i∈{1, 2}. Cyclic delay δᵢ, i∈{1, 2} can be defined/identified as follows:

In one option, δ₁ and δ₂ are the same i.e., δ₁=δ₂=δ. In another example, the value of δ can be pre-determined in the specification. For example, δ=5. In another example, the value of a can be estimated at the BS 20 and report to the UE in DCI. As another example, the set of values for a can be specified in the specification and use x-bits in DCI, which the BS 20 can inform UE which δ value to use. In another example, the set of values for δ can be informed to the UE using higher layer signaling. In this option, using x-bits in DCI, the BS 20 can inform UE which δ value to use out of that set.

In another set of options, δ₁ and δ₂ are different i.e., δ₁≠δ₂. Here, in one option the values of δ₁ and δ₂ can be pre-determined in the specification. For example, δ₁=5, δ₂=7. In another example, the values of δ₁ and δ₂ can be estimated at the BS 20 and reported to the UE in DCI. As another example, the set of values for δ₁ and δ₂ can be specified in the specification using x-bits in DCI, which the BS 20 can inform a UE which δ₁ and δ₂ values to use. For example, four possible values {5, 6, 7, 8} specified in the specification to select δ₁ and δ₂. In this example, using

$$x = {log}_{2} ( \begin{matrix}4 \\ 2\end{matrix} )$$

bits the BS 20 can inform UE which value pair to use. In another example, the set of values for δ₁ and δ₂ can be informed to the UE using higher layer signaling. Then using x-bits in DCI, the BS 20 can inform the UE which δ₁ and δ₂ values to use out of that set. For example, four possible values {5, 6, 7, 8} are informed to UE using higher-layer signaling. In this example, using

$$x = {log}_{2} ( \begin{matrix}4 \\ 2\end{matrix} )$$

bits the BS 20 can inform the UE which value pair to use from that set.

Advantageously, with CDD based UL transmission, received power for each stream can be enhanced at the UL. Further, better sum-rates compared to release (Rel.) 15 two-layer, four port transmission can be expected due to single bit port-stream mapping. Additionally, interference averaging can be achieved by selecting δ₁ and δ₂ appropriately

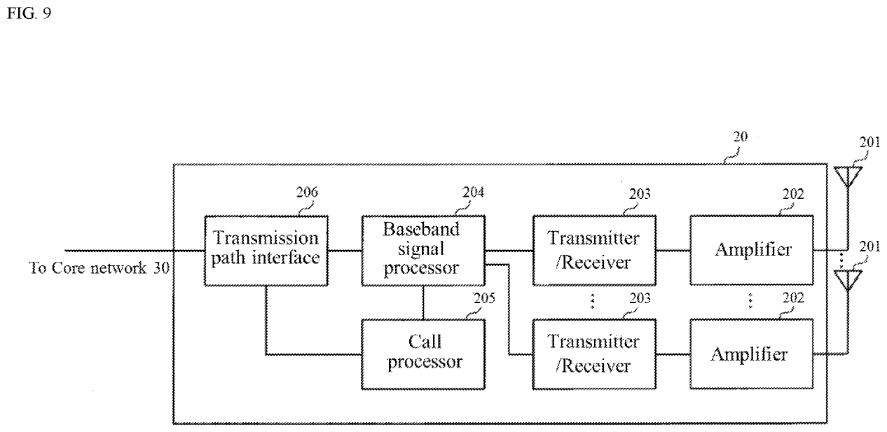

The BS 20 according to one or more embodiments of the present invention will be described below with reference to the FIG. 9.

As shown in FIG. 9, the BS 20 may comprise an antenna 201 for 3D MIMO, an amplifier 202, a transmitter/receiver circuit 203 (hereinafter referred as including a CSI-RS scheduler), a baseband signal processor 204 (hereinafter referred as including a CS-RS generator), a call processor 205, and a transmission path interface 206. The transmitter/receiver 202 includes a transmitter and a receiver.

The antenna 201 may comprise a multi-dimensional antenna that includes multiple antenna elements such as a 2D antenna (planar antenna) or a 3D antenna such as antennas arranged in a cylindrical shape or antennas arranged in a cube. The antenna 201 includes antenna ports having one or more antenna elements. The beam transmitted from each of the antenna ports is controlled to perform 3D MIMO communication with the UE 10.

The antenna 201 allows the number of antenna elements to be easily increased compared with linear array antenna. MIMO transmission using a large number of antenna elements is expected to further improve system performance. For example, with the 3D beamforming, high beamforming gain is also expected according to an increase in the number of antennas. Furthermore, MIMO transmission is also advantageous in terms of interference reduction, for example, by null point control of beams, and effects such as interference rejection among users in multi-user MIMO can be expected.

The amplifier 202 generates input signals to the antenna 201 and performs reception processing of output signals from the antenna 201.

The transmitter included in the transmitter/receiver circuit 203 transmits data signals (for example, reference signals and precoded data signals) via the antenna 201 to the UE 10.

The call processor 205 determines a precoder applied to the downlink data signals and the downlink reference signals. The precoder is called a precoding vector or more generally a precoding matrix. The call processor 205 determines the precoding vector (precoding matrix) of the downlink based on the CSI indicating the estimated downlink channel states and the decoded CSI feedback information inputted.

The transmission path interface 206 multiplexes CSI-RS on REs based on the determined CSI-RS resources by the CSI-RS scheduler 203.

The transmitted reference signals may be Cell-specific or UE-specific. For example, the reference signals may be multiplexed on the signal such as PDSCH, and the reference signal may be precoded. Here, by notifying a transmission rank of reference signals to the UE 10, estimation for the channel states may be realized at the suitable rank according to the channel states.

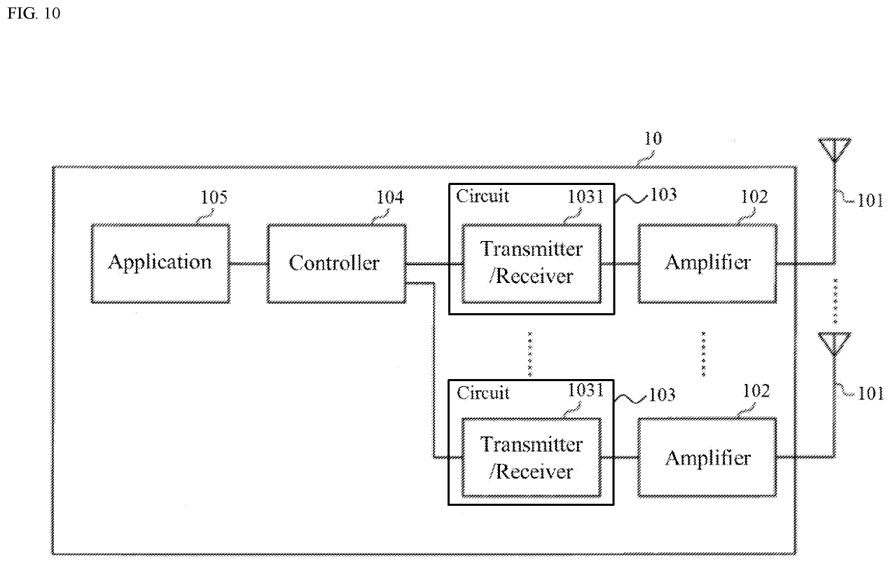

The UE 10 according to one or more embodiments of the present invention will be described below with reference to the FIG. 10.

As shown in FIG. 10, the UE 10 may comprise a UE antenna 101 used for communicating with the BS 20, an amplifier 102, a transmitter/receiver circuit 103, a controller 104, the controller including a CSI feedback controller, and a CSI-RS controller. The transmitter/receiver circuit 103 includes a transmitter and a receiver 1031.

The transmitter included in the transmitter/receiver circuit 103 transmits data signals (for example, reference signals and the CSI feedback information) via the UE antenna 101 to the BS 20.

The receiver included in the transmitter/receiver circuit 103 receives data signals (for example, reference signals such as CSI-RS) via the UE antenna 11 from the BS 20.

The amplifier 102 separates a PDCCH signal from a signal received from the BS 20.

The controller 104 estimates downlink channel states based on the CSI-RS transmitted from the BS 20, and then outputs a CSI feedback controller.

The CSI feedback controller generates the CSI feedback information based on the estimated downlink channel states using the reference signals for estimating downlink channel states. The CSI feedback controller outputs the generated CSI feedback information to the transmitter, and then the transmitter transmits the CSI feedback information to the BS 20. The CSI feedback information may include at least one of Rank Indicator (RI), PMI, CQI, BI and the like.

The CSI-RS controller determines whether the specific user equipment is the user equipment itself based on the CSI-RS resource information when CSI-RS is transmitted from the BS 20. When the CSI-RS controller 16 determines that the specific user equipment is the user equipment itself, the transmitter that CSI feedback based on the CSI-RS to the BS 20.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of applying rank two transmission from a plurality of sets of coherent antennas of a user equipment (UE) in a wireless communication system, the method comprising:
transmitting two information streams using a first set from the plurality of sets of coherent antennas of the UE; and
transmitting the two information streams using a second set from the plurality of sets of the coherent antennas of the UE,
wherein the first set and the second set are incoherent with respect to each other, and
wherein the two information streams are common to the first set and the second set.

2. A method of applying cyclic delay diversity (CDD) across coherent pairs of antennas of a user equipment (UE) in a wireless communication system, the method comprising:
transmitting two information streams across a first set of coherent antennas of the UE; and
transmitting the two information streams across the second set of the coherent antennas of the UE,
wherein the two information streams across the first set are transmitted with a delay based on the CDD from the two information streams transmitted across the second set.

3. A method of applying single-bit port-stream mapping, comprising:
determining, with the UE, port channel gains for a two-layer, four port uplink (UL) transmission of a partial coherent user equipment.

4. A method of precoding in a wireless communication system, comprising:
obtaining, with a base station (BS), a release 15 codebook including at least one of partial coherent codewords or full coherent codewords; and
applying, with the BS, precoding to a stream based on the release 15 codebook.

5. A method of precoding in a wireless communication system, comprising:
defining, in the wireless communication system, a codebook including one or more codewords applicable to two-layer, four port uplink transmission for a user equipment (UE),
wherein the one or more codewords apply to zero forcing (ZF) precoding of coherent antenna pairs for the UE.
